(19) United States
(12) Patent Application Publication
(10) Pub. No.: US 2026/0360852 A1
(43) Pub. Date: Nov. 12, 2026

(54) TRACTION-BATTERY ASSEMBLY WITH THERMALLY ENHANCED COOLING FIN

(71) Applicant: FORD GLOBAL TECHNOLOGIES, LLC, Dearborn, MI (US)

(72) Inventors: Gang GUO, Saline, MI (US); Claudia JAZOWSKI, Ferndale, MI (US); Soo Yeon LIM, Canton, MI (US); Jiyun PARK, Troy, MI (US)

(21) Appl. No.: 19/203,796

(22) Filed: May 9, 2025

(51) Int. Cl. H01M 10/6551; H01M 10/613; H01M 10/625; H01M 10/653; H01M 10/6556

(52) U.S. Cl. CPC H01M 10/6551; H01M 10/613; H01M 10/625; H01M 10/653; H01M 10/6556

(57) ABSTRACT

A traction battery includes a cold plate having a cooling surface and a fin extending from the cooling surface. A battery array is disposed on the cooling surface with a face of the fin disposed against a cell of the battery array. An arrangement of discrete metal pieces is disposed on the face of the fin and in contact with the cell. The metal pieces have a higher thermal conductivity than the fin and the metal pieces are positioned within the arrangement such that the metal pieces are spaced from each other.

### TECHNICAL FIELD

The present disclosure relates to traction-battery assemblies for motor vehicles and more particularly to cooling and heating traction-battery assemblies.

### BACKGROUND

Vehicles such as battery-electric vehicles (BEVs), plug-in hybrid electric vehicles (PHEVs), and full hybrid-electric vehicles (FHEVs) contain a traction battery assembly to act as an energy source for vehicle propulsion. The traction battery includes components and systems to assist in managing vehicle performance and operations. The traction battery also includes high voltage components. Traction batteries may include an air or liquid thermal management system to control the temperature of the battery.

### SUMMARY

According to one embodiment, a traction battery includes a cold plate having a cooling surface and a fin extending from the cooling surface. A battery array is disposed on the cooling surface with a face of the fin disposed against a cell of the battery array. An arrangement of discrete metal pieces is disposed on the face of the fin and in contact with the cell. The metal pieces have a higher thermal conductivity than the fin and the metal pieces are positioned within the arrangement such that the metal pieces are spaced from each other.

According to another embodiment, a traction battery includes a plurality of cells stacked in an array, a cold plate in thermal contact with the array, at least one cooling fin coupled to the cold plate and having a face disposed against a major side of one of the cells, and a thermally conductive patch disposed on only a portion of the face of the fin. The portion is located on the fin such that the portion is disposed against an area of the major side that is configured to generate more heat than another area of the side during operation of the traction battery.

According to yet another embodiment, a traction battery includes a cold plate and a battery array in thermal contact with the cold plate and including a stack of cells interleaved with cooling fins coupled to the cold plate. The faces of the fins are disposed against major sides of the cells. A pattern of thermally conductive material is disposed on each of the fins and in contact with corresponding ones of the cells. The thermally conductive material has a higher thermal conductivity than the fin.

### BRIEF DESCRIPTION OF THE DRAWINGS

FIG. 1 is a schematic diagram of a typical plug-in hybrid-electric vehicle.

FIG. 2 is a perspective view of a traction-battery assembly.

FIG. 3 diagrammatical perspective view of a battery-cell array disposed on a cold plate.

FIG. 4 is a partial side view of the battery-cell array and cold plate of FIG. 3.

FIG. 5 is a front view of a battery cell of the traction-battery assembly showing three different thermal zones that heat differently during operation of the cell.

FIG. 6 illustrates a front view of a cooling fin with thermal enhancement according to one embodiment of this disclosure.

FIG. 7 illustrates a front view of a cooling fin with thermal enhancement according to another embodiment of this disclosure.

FIG. 8 illustrates a front view of a cooling fin with thermal enhancement according to yet another embodiment of this disclosure.

FIG. 9 illustrates a front view of a cooling fin with thermal enhancement according to a further embodiment of this disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

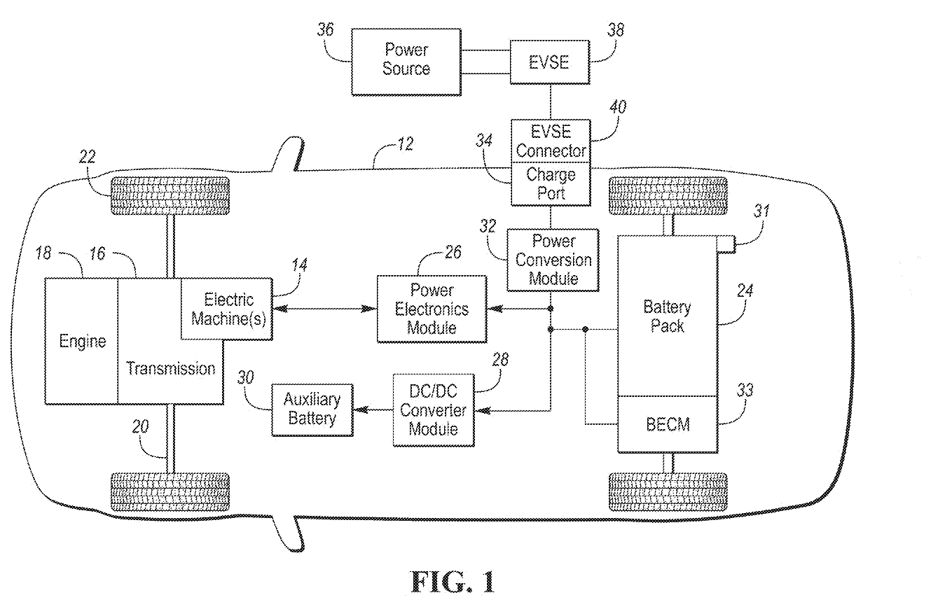

FIG. 1 depicts a schematic of a typical plug-in hybrid-electric vehicle (PHEV). Certain embodiments of this disclosure may be implemented within the context of non-plug-in hybrids and fully electric vehicles. The vehicle 12 includes one or more electric machines 14 mechanically connected to a hybrid transmission 16. The electric machines 14 may be capable of operating as a motor or a generator. In addition, the hybrid transmission 16 may be mechanically connected to an engine 18. The hybrid transmission 16 may also be mechanically connected to a drive shaft 20 that is mechanically connected to the wheels 22. The electric machines 14 can provide propulsion and braking capability when the engine 18 is turned ON or OFF. The electric machines 14 also act as generators providing fuel economy benefits by recovering energy through regenerative braking. The electric machines 14 reduce pollutant emissions and increase fuel economy by reducing the workload of the engine 18.

A traction-battery assembly or battery pack 24 stores energy used by the electric machines 14. The traction battery 24 typically provides a high-voltage direct current (DC) output from one or more battery cell arrays, sometimes referred to as battery cell stacks, within the traction battery 24. Each battery cell array includes one or more battery cells.

The battery cells, such as a prismatic or pouch cells, include electrochemical cells that convert stored chemical energy to electrical energy. The cells include a housing or pouch, a positive electrode (cathode) and a negative electrode (anode). An electrolyte allows ions to move between the anode and cathode during discharge, and then return during recharge. The electrolyte may be liquid or solid state. Terminals allow current to flow out of the cell for use by the vehicle. When positioned in an array with multiple battery cells, the terminals of each battery cell may be aligned with opposing terminals (positive and negative) adjacent to one another and a busbar may facilitate a series connection between the multiple battery cells. The battery cells may also be arranged in parallel such that like terminals (positive-positive or negative-negative) are adjacent and coupled to one another.

Different battery pack configurations are available to address individual vehicle variables including packaging constraints and power requirements. The battery cells may be heated or cooled with a thermal-management system. Examples thermal-management systems include air-cooling systems, liquid-cooling systems, and a combination of air-and-liquid systems.

The traction battery 24 may be electrically connected to one or more power-electronics modules 26 through one or more contactors (not shown). The one or more contactors isolate the traction battery 24 from other components when opened and connect the traction battery 24 to other components when closed. The power-electronics module 26 may be electrically connected to the electric machines 14 and may provide the ability to bi-directionally transfer electrical energy between the traction battery 24 and the electric machines 14. For example, a typical traction battery 24 provides DC while the electric machines 14 require a three-phase alternating current (AC). The power-electronics module 26 may convert the DC of the batteries to three-phase AC as required by the electric machines 14. In a regenerative mode, the power-electronics module 26 may convert the three-phase AC from the electric machines 14 acting as generators to DC as required by the traction battery 24.

The description herein is equally applicable to a fully electric vehicle. In a fully electric vehicle, the hybrid transmission 16 may be a gear box connected to an electric machine 14 and the engine 18 is not present. A fully electric vehicle according to this disclosure may include a one powered axle, e.g., rear wheel drive, or may include two powertrain units to power both the front and rear axles providing all-wheel drive.

In addition to providing energy for propulsion, the traction battery 24 may provide energy for other vehicle electrical systems. A typical system may include a DC/DC converter module 28 that converts the high-voltage DC output of the traction battery 24 to a low-voltage DC supply that is compatible with other vehicle loads. Other high-voltage loads, such as compressors and electric heaters, may be connected directly to the high voltage without the use of a DC/DC converter module 28. In a typical vehicle, the low-voltage systems are electrically connected to an auxiliary battery 30 (e.g., a 12-volt battery). The DC/DC converter may also modify the voltage going to the electric machines 14.

A battery electric control module (BECM) 33 may be in communication with the traction battery 24. The BECM 33 may act as a controller for the traction battery 24 and may also include a monitoring system that manages temperature and state-of-charge (SOC) for each of the battery cells. The traction battery 24 may have one or more temperature sensors 31. The temperature sensors 31 may be in communication with the BECM 33 to provide temperature data regarding the traction battery 24.

The vehicle 12 may be recharged by an external power source 36. The external power source 36 may be a connection to an electrical outlet. The external power source 36 may be electrically connected to electric vehicle supply equipment (EVSE) 38. The EVSE 38 may provide circuitry and controls to manage the transfer of electrical energy between the power source 36 and the vehicle 12. The external power source 36 may provide DC or AC electric power to the EVSE 38. The EVSE 38 may have a charge connector 40 for plugging into a charge port 34 of the vehicle 12. The charge port 34 may be any type of port configured to transfer power from the EVSE 38 to the vehicle 12. The charge port 34 may be electrically connected to a charger or on-board power conversion module 32. The power conversion module 32 may condition the power supplied from the EVSE 38 to provide the proper voltage and current levels to the traction battery 24. The power conversion module 32 may interface with the EVSE 38 to coordinate the delivery of power to the vehicle 12. The EVSE connector 40 may have pins that mate with corresponding recesses of the charge port 34, or vise versa.

The various components discussed may have one or more associated controllers to control and monitor the operation of the components. The controllers may communicate via a serial bus (e.g., Controller Area Network (CAN)) or via dedicated electrical conduits.

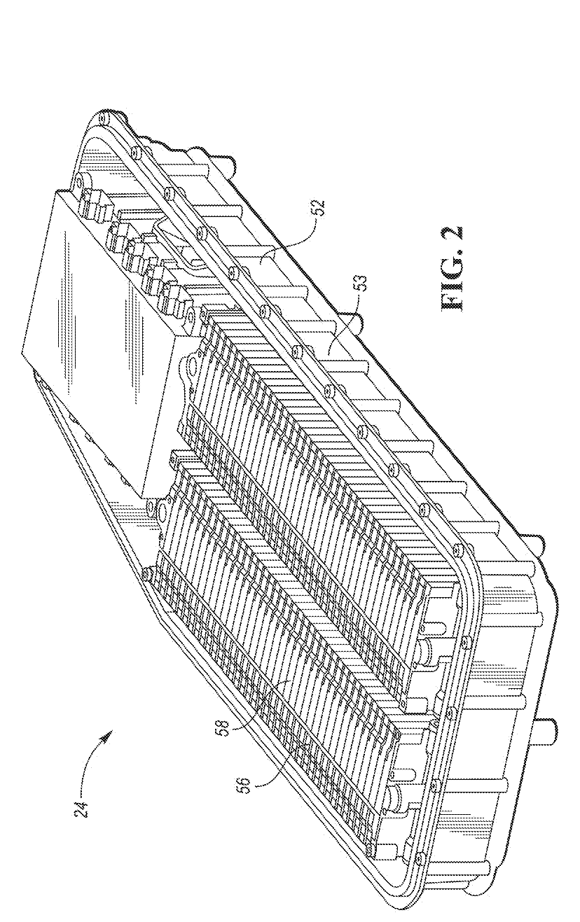

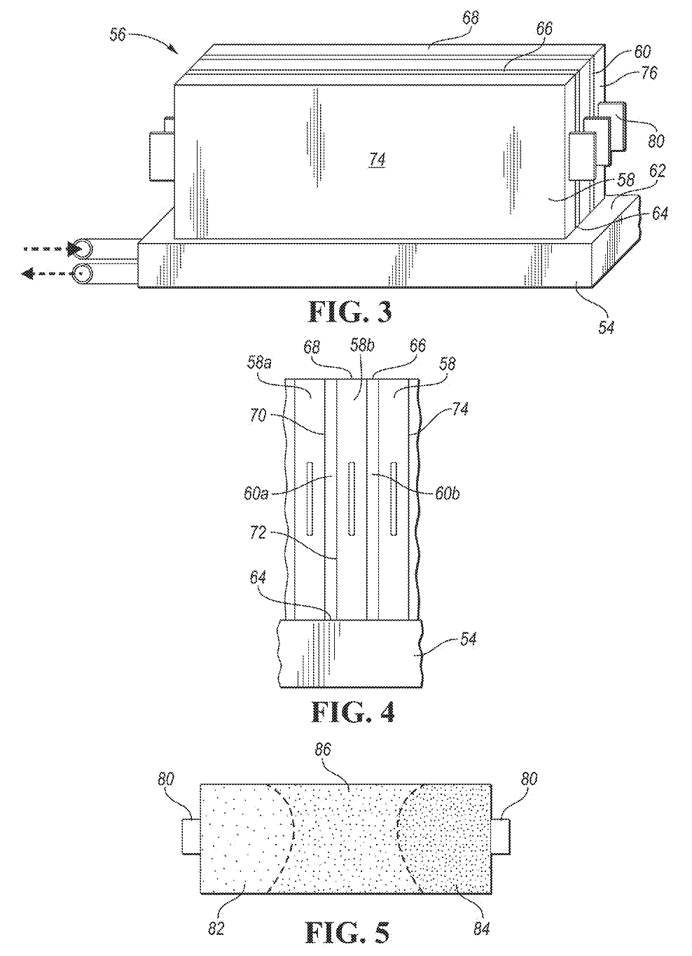

FIGS. 2 through 9, and the related discussion, describe examples of the traction-battery assembly 24. Referring to FIGS. 2 and 3, the traction-battery assembly 24 includes a case 52 having a tray 53 and a cover (not shown). One or more cold plates 54 are disposed on a bottom of the case 52. The cold plate(s) 54 can heat or cool the battery depending upon the temperature of coolant circulating therethrough. For example, the cold plate 54 is configured to circulate a cold fluid (liquid coolant) to remove heat from the case 52 or circulate a hot fluid to warm the case 52. At least one battery array 56 is disposed on the thermal plate 54. In the illustrated embodiment, a pair of arrays 56 are shown. These arrays may share a single cold plate or each may have a dedicated cold plate. In other embodiments, the traction battery 24 may include three or more arrays 56.

Each battery array 56 includes a plurality of battery cells 58 stacked together and electrically connected in series or parallel or a combination thereof. The thermal plate 54 may be in contact with each of the battery cells 58 and may add or remove heat to the cells depending upon operating conditions. For example, if the cells 58 are above a threshold temperature, a relatively cold fluid is circulated to the cold plate 54 to cool the battery cells. Alternatively, if the battery cells 58 are below the threshold temperature, a relatively warm fluid is circulated through the cold plate 54 to add heat to the battery cells. The warm fluid may be provided by an internal combustion engine, a heat pump, or an electric heater depending upon the vehicle type and thermal conditions, e.g., is the engine warm or cold. An optional thermal interface material (TIM) may be disposed between the cells 58 and the thermal plate 54. The TIM may be a pad, a gel, a paste, or the like.

Referring to FIGS. 2 and 3, the cold plate 54 includes an upper surface 62 that supports one or more of the battery arrays 56. For example, the one or more battery arrays 56 may be disposed on the upper surface 62. This may result in the bottoms of the individual cells 58 touching the upper surface 62 or a thermal interface material disposed thereon. Alternatively, the individual cells 58 may be spaced slightly above the upper surface 62. To increase the thermal efficiency, thermal fins 60 are used to contact the cell surfaces and dissipate to or add heat from the cells. The thermal fins may be integrated into the battery array and make contact with cold plate 54 through thermal interface material. That is, the fins 60 are interleaved with the battery cells 58 and are part of the array stack. The fins 60 may be arranged in the array so that each fin 60 is sandwiched between a pair of adjacent cells. In some embodiments, the pattern of fins and cells is one after the other (as shown). In other embodiments, a fin 60 may be provided every two cells are every three cells depending upon cooling needs.

In example embodiment, the fins 60 are plate-like structures. The fins 60 are formed from a highly thermally conductive material, such as aluminum. Each fin 60 includes a bottom portion 64 that is coupled to the cold plate 54. The bottom portion 64 may be enlarged to facilitate connection with the cold plate 54. The fin 60 extends from the bottom portion 64 to a top portion 66 that may or may not coincide with the tops 68 of the cells 58. The fins 60 have opposing faces 70, 72 on opposite sides of the fin 60. The faces 70, 72 may be perpendicular to the longitudinal direction of the battery array 56. The faces 70, 72 are designed to contact the battery cells 58 to add or remove heat therefrom depending upon operating conditions. In the illustrated example, the cells 58 are pouch-type cells that have major sides 74 joined along the edges 76. However, this disclosure is equally applicable to prismatic battery cells. The faces 70, 72 are disposed against the major sides 74. For example, the fin 60a has its first face 70 disposed against the major side 74 of a first cell 58a and its second face 72 disposed against the major side 74 of a second cell 58b. In some embodiments, the fins may be compressed with the battery cells insuring good contact therebetween.

Most battery cells do not heat evenly because different portions of the battery cell generate more heat than others. This created a temperature gradient where some regions of the cell are hotter than others. Typically, the cells 58 are hotter near the terminals 80 and colder as you move away from the terminals, although, the specific temperature gradient will vary based on the specific design of the battery cell. FIG. 5 illustrates this concept showing hotter zones 82 and 84 near the terminals 80 and a cooler zone 86 located away from the terminals. This is merely a simplified example to highlight the concept. It is understood that there are temperature gradients within each of the shown zones and that the cell may be broken down into a higher number of zones to more accurately reflect the temperature gradients present.

As described above, each of the fin has faces disposed against major sides of the cells. Traditionally, the fins were formed from homogeneous material such as an aluminum plate. Thus, the ability of the fin to transfer heat from the cell is generally uniform. However, as discussed above, the temperature of the cell is not uniform. This may result in portions of the fin being oversized and other portions being undersized, i.e., having too much or too little thermal conductivity in different areas of the fin.

In one approach, the fin may have a generally uniform thickness sized according to warmest area of the cell. This approach, however, results in over capacity for the cooler areas of the cell and increases stack the length and weight. Rather than increase the overall thermal conductivity of the fins to meet the requirements of warmer zones of the cell, described below is a targeted approach where the thermal conductivity of the fin is only increased at areas that require additional cooling capacity. This allows for performance benefits without increasing the packaging size (and may actually reduce size) of the fins.

One way to increase thermal conductivity of the fin is to add a material with higher thermal conductivity. While aluminum is a good conductor of heat, other metals, such as silver, copper, and gold, have higher thermal conductivity. Adding any of these better thermal conductors to the fin increases the thermal conductivity. These materials, however, need not be applied to the entire face of the fin due to the temperature gradients of the battery cells. That is, these materials may only be added to the fin at targeted locations that correspond with the warmer zones 82, 84. This helps to better match the fin thermal conductivity to the temperature gradient of the battery cell. In some embodiment, the better thermal conductor may be applied to the entire face of the fin, which may allow for a reduction in fin mass and/or thickness.

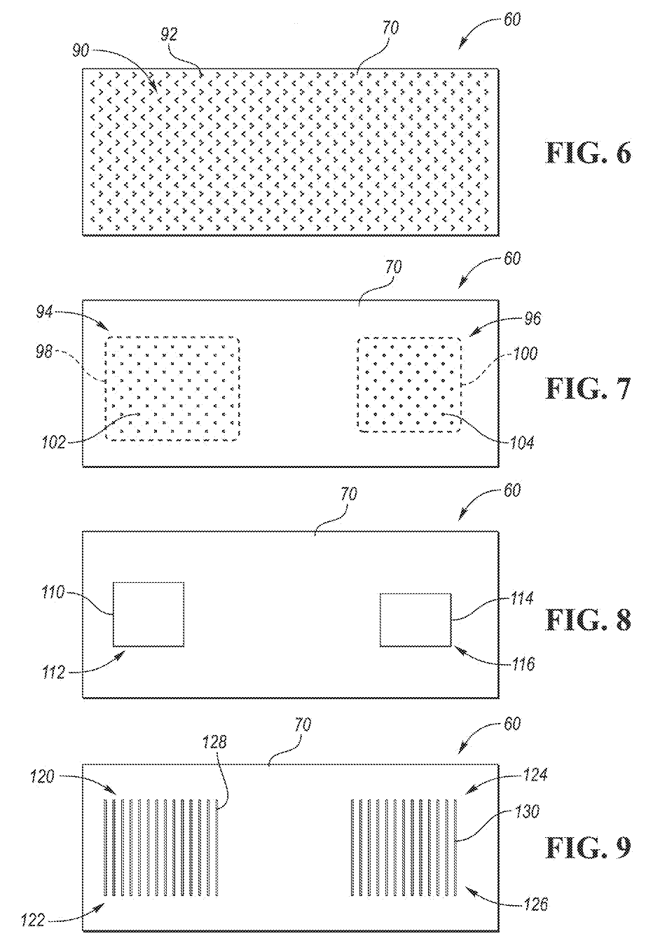

FIG. 6 illustrates an example pattern 90 of additional thermally conductive material applied on the face 70 of a fin 60. In this example, the pattern 90 is uniformly applied across the entire face 70. The pattern 90 may be formed by a plurality of discrete and individual pieces of metal 92 that have a higher thermal conductivity than the fin 60. For example, the metal pieces 92 may be formed from copper, silver, or gold, whereas the fin is aluminum. The pieces 92 may be thin and have a planer surface for engaging with the cells. In the example of FIG. 6, the pieces 92 are small chevron-shaped pieces but may be any suitable shape such as squares, dots, triangles, rectangles, ovals and the like. Additionally, the pieces 92 may be larger or smaller than those shown in the example of FIG. 6. The pieces 92 may be joined to the fin 60 by any suitable technique such as adhesive, soldering, brazing, welding, depositing, or the like. The pieces 92 may be held in place on a sheet that is then applied to the fin 60. The other face 72 of the fin 60 may include the pattern 90 as well.

FIG. 7 illustrates another example in which the additional thermally conductive material is selectively applied to only a portion of the face 70 of the fin 60. Here, a first pattern of thermally conductive material 94 is placed on a first portion 98 of the face 70 and a second pattern of thermally conductive material 96 is placed on a second portion 100 of the face. The placement of the patterns 94 and 96 correspond to the warmer zones of the battery cell. That is, the patterns 94 and 96 contact the warmer zones of the battery cell to provide additional cooling where it is needed. Like above, each of the patterns 94, 96 include a plurality of discrete pieces 102, 104. The other face 72 of the fin 60 may include the patterns 94, 96 as well.

FIG. 8 illustrates another example in which patches of additional thermally conductive material are applied to select areas of the face 70 of the fin 60 the correspond with the warmer zones of the battery cell. For example, a first patch of thermally conductive material 110 is disposed on the face 70 at a first portion 112 and a second patch of thermally conductive material 114 is disposed on the face 70 at a second portion 116. Each of the patches may include a thin layer of material, e.g., metal, having a higher thermal conductivity than the fin 60, e.g., aluminum. For example, the patches may be a thin sheet of copper, silver, or gold that is secured to the face 70 by adhesive, brazing, soldering, welding, depositing, or the like. In this example, the patch 110 is larger than the patch 114 because the patch 110 is configured to be disposed against a zone of the cell that is warmer than the zone of the cell that patch 114 contacts. That is, the size of the patches is tuned to match the thermal characteristics of the cell to which it is coupled. The other face 72 of the fin 60 may include the patches 110, 114 as well.

FIG. 9 illustrates an example where the additional thermally conductive material is arranged as patterns of strips. A first arrangement of metal strips 120 is placed on a first area 122 of the face 70 and a second arrangement of strips 124 is placed on a second area 126 of the face 70 of the fin 60. The first arrangement 120 includes a plurality of metal strips 128 that are spaced from each other. In the illustrated example, all of the strips 128 are parallel to each other and are spaced equidistant. In other embodiments, the spacing between the strips may vary and the strips may have different widths and/or lengths. The strips 128 may be oriented to extend vertically (as shown) or may be placed in other orientation such as horizontally or diagonally. The strips 128 may be cut from a thin sheet of copper, silver, or gold. The second arrangement 124 includes a plurality of metal strips 130 that are spaced from each other. In the illustrated example, all of the strips 130 are parallel to each other and are spaced equidistant. In other embodiments, the spacing between the strips may vary and the strips may have different widths and/or lengths. The strips 130 may be oriented to extend vertically (as shown) or may be placed in other orientation such as horizontally or diagonally. The strips 130 may be cut from a thin sheet of copper, silver, or gold. The strips may be attached to the fin 60 by adhesive, brazing, soldering, welding, depositing, or the like. In this example, the first arrangement 120 is larger than the second arrangement 124 due to the thermal gradient of the battery cell. That is, the first arrangement 120 is configured to be disposed against an area of the cell that is warmer than the area in contact with the second arrangement 124.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A traction battery comprising:
a cold plate including a cooling surface and a fin extending from the cooling surface;
a battery array disposed on the cooling surface, wherein a face of the fin is disposed against a cell of the battery array; and
an arrangement of discrete metal pieces disposed on the face of the fin and in contact with the cell, wherein the metal pieces have a higher thermal conductivity than the fin and wherein the metal pieces are positioned within the arrangement such that the metal pieces are spaced from each other.

2. The traction battery of claim 1, wherein the metal pieces are copper, silver, or gold.

3. The traction battery of claim 1, wherein the cell includes a first zone that is warmer than a second zone during operation of the traction battery, wherein the arrangement is contact with first zone but not the second zone.

4. The traction battery of claim 1, wherein the pieces are strips or dots.

5. The traction battery of claim 1, wherein the pieces are strips disposed on the face such that each of the strips are parallel to each other.

6. The traction battery of claim 5, wherein the strips are spaced equidistant to each other.

7. The traction battery of claim 1, wherein a second face of the fin is disposed against another cell of the battery array, and further comprising another arrangement of discrete metal pieces disposed on the second face of the fin and in contact with the another cell, wherein the metal pieces of the another arrangement have a higher thermal conductivity than the fin and wherein the metal pieces are positioned within the another arrangement such that the metal pieces are spaced from each other.

8. The traction battery of claim 1, wherein the arrangement covers only a portion of the face of the fin.

9. The traction battery of claim 8, wherein the arrangement covers less than half of the face of the fin.

10. A traction battery comprising:
a plurality of cells stacked in an array;
a cold plate in thermal contact with the array;
at least one cooling fin coupled to the cold plate and having a face disposed against a major side of one of the cells; and
a thermally conductive patch disposed on only a portion of the face of the fin, wherein the portion is located on the fin such that the portion is disposed against an area of the major side that is configured to generate more heat than another area of the side during operation of the traction battery.

11. The traction battery of claim 10, wherein the patch has a higher thermal conductivity than the fin.

12. The traction battery of claim 11, wherein the fin is aluminum and the patch is copper, silver, or gold.

13. The traction battery of claim 10, wherein the patch is a metal film having a higher thermal conductivity than the fin.

14. The traction battery of claim 10, wherein the fin has a second face disposed against a second major side of another one of the cells, and further comprising a second thermally conductive patch disposed on only a second portion of the second face of the fin, wherein the second portion is located on the fin such that the second portion is disposed against an area of the second major side that is configured to heat more than the another area of the second major side.

15. A traction battery comprising:
a cold plate;
a battery array in thermal contact with the cold plate and including a stack of cells interleaved with cooling fins coupled to the cold plate, wherein faces of the fins are disposed against major sides of the cells; and
a pattern of thermally conductive material disposed on each of the fins and in contact with corresponding ones of the cells, wherein the thermally conductive material has a higher thermal conductivity than the fin.

16. The traction battery of claim 15, wherein the pattern includes a plurality of strips that are spaced from each other.

17. The traction battery of claim 16, wherein the strips are arranged parallel to each other.

18. The traction battery of claim 15, wherein the pattern includes a plurality of dots.

19. The traction battery of claim 15, wherein the pattern is only disposed on a portion of the fin.

20. The traction battery of claim 15, wherein the thermally conductive material is copper, silver, or gold.
